(19) United States
(12) Patent Application Publication
(10) Pub. No.: US 2016/0092658 A1
(43) Pub. Date: Mar. 31, 2016

(54) METHOD OF EVALUATING INFORMATION TECHNOLOGIES

(71) Applicant: Marianne LEENAERTS, Victoria (CA)

(72) Inventor: Marianne LEENAERTS, Victoria (CA)

(21) Appl. No.: 14/856,816

(22) Filed: Sep. 17, 2015

Related U.S. Application Data
(60) Provisional application No. 62/055,249, filed on Sep. 25, 2014.

(51) Int. Cl. G06F 19/00

(52) U.S. Cl. CPC G06F 19/363

(57) ABSTRACT

A computer implemented method of evaluating an information technology in a computer network having multiple applications and users. The computer is programmed to create objective metric data of organizational, technical and utilization dimensions. This is accomplished through quantitative and qualitative data collection methods, such as surveys, usage tracking and system monitoring. The computer is programmed to create objective metric data on actual use and performance. From the metric data of organizational, utilization, and technical dimensions the computer is able to provide an analysis of the overall degree of utilization, individual net benefits and organizational net benefits. As data is compiled, the method produces industry sector standards for the purpose of benchmarking.

### FIELD

There is described a method of evaluating information technologies. This method was developed for use in health care institutions, but has broader application.

### BACKGROUND

Though evaluation is commonly used in most sectors of the economy, it is not applied to information technology. Neither the performance nor the effectiveness and efficiency of these systems are assessed in a systematic and comprehensive manner. As a result, organizations cannot demonstrate the measurable impact of their systems on expected outcomes, i.e. the net benefits of the systems and their attainment through effective and efficient use. The absence of evaluation also precludes a determination of how well information systems serve strategic objectives at the corporate level. More importantly, the lack of assessment hampers decision-makers in determining and prioritizing needed improvements. The absence of evaluation affects all sectors of the economy, including the information technology industry.

The absence of evaluation is particularly detrimental to the healthcare sector. Unprecedented reforms are being introduced which rely heavily on the development and use of health information systems. Transparency, accountability and the provision of factual evidence of progress and impact on care itself are critical needs. Further, the absence of evaluation prevents the establishment and adoption of standards, thus precluding sound and objective benchmarking and the dissemination of best practices across the healthcare sector. There is, therefore, a need for a method for objectively evaluating information technologies.

### SUMMARY

There is provided a computer implemented method of evaluating an information technology in a computer network having multiple applications and users. A step is taken of programming a computer to create objective metric data of organizational dimension. This is accomplished from surveys regarding business needs associated with each information technology application and the contributions each information technology application is intended to make toward advancing an organization's goals and mission. The resulting metric data includes a minimum of a level of identification of business drivers for each information technology application, a level of identification of areas targeted for process improvement by each information technology application, and a level of identification of areas targeted for cost savings by each information technology application. A step is taken of programming the computer to create objective metric data of utilization dimension. This is accomplished from surveys regarding users' needs, their motivation for using each information technology application, the nature of their use of each information technology application. The resulting metric data includes a minimum of an amount of use of each information technology application, a frequency of use of each information technology application, a duration of use of each information technology application, a motivation of use of each information technology application, and a nature of use of each information technology application. A step is taken of programming the computer to create objective metric data of technical dimension. This is accomplished by monitoring actual use and performance of each information technology application. The resulting metric data includes a minimum of: a number of users, an amount of use of each information technology application, a frequency of use of each information technology application, and a duration of use of each information technology application. A step is taken of programming the computer to process the metric data of organizational dimension, the metric data of utilization dimension, and the metric data of technical dimension to determine the overall degree of utilization of each information technology application. A step is taken of programming the computer to create objective metric data of individual net benefits to determine the positive impact of each information technology application on users' productivity. This resulting metric data includes a minimum of a level of increase in analytical capability. A step is taken of programming the computer to create objective metric data of organizational net benefits to determine the positive impact of each information technology application on the organization as a whole. This resulting metric data includes a minimum of a level of increase in the capability to achieve goals and mission.

Although the literature extols the benefits of information systems, further research reveals the existence of suboptimal results, unintended consequences, and in some instances, even failure. Furthermore, there is little evidence of information systems' assessment. The above method affords guidance by providing the means to identify the causes of suboptimal results and take remedial action. By following the method steps outlined above, one can arrive at an objective evaluation of whether the information technology is meeting the needs of the organization and of the users. An underlying assumption is that an analysis of metric data will ultimately determine whether the information technology is functioning to deliver the intended benefits. As will hereinafter be further described, a difficulty encountered is in arriving at and extracting metric data that will provide the basis for an assessment of performance.

Where the baseline performance is suboptimal, further steps are taken of conducting a review of impediments leading to the baseline performance of the information technology being suboptimal to determine possible remedial action and monitoring metric data for a time interval after the remedial action has been implemented to determine whether there has been an improvement in baseline performance. It is expected that in a vast majority of reviews, performance will be determined to be suboptimal with remedial action recommended.

As impediments leading to the baseline performance of the information technology being suboptimal can come from a number of sources or a combination of sources, the review of impediments to the baseline performance includes a review of technical impediments, organizational impediments and utilization impediments. It is necessary that the review be comprehensive and encompass all three areas. Each of these areas influence and impact the other areas.

In order to determine the impediments to baseline performance, feedback is obtained from users through the use of quantitative and qualitative survey methods, i.e. questionnaires, interviews and focus groups. This is in addition to reviewing project management documentation, system management documentation, testing the systems, and reviewing logs and all other documentation created during the design, implementation and use of the system.

There is frequently more than one piece of metric data generated for an information technology. In fact, upon a comprehensive review there is so much metric data generated that it can become almost overwhelming. Where there is more than one piece of metric data for the information technology, it is recommended to assign relative importance to each piece of metric data through a ranking system. In the face of overwhelming volumes of metric data, it is recommended to also use a weighting system in which relative weight is given to the pieces of metric data to produce a score.

Greater insight is obtained when the users are grouped, for the purpose of analysis, based upon the nature of their duties. For example, users can be grouped as being management personnel, financial and operations personnel, or service delivery personnel. The reason for this is that certain information technologies may be used daily by service delivery personnel and only used intermittently by management personnel. Similarly, certain information technologies may be used daily by financial and operations personnel, only intermittently by management personnel, and only rarely by service delivery personnel. The reason for this is that their underlying needs may be different. Additionally, it is necessary to distinguish primary and secondary users. Primary users have full access to and control over the use of the information system, while secondary users have limited access to the system and can only control those functions they are allowed to use. Moreover, primary users may in some instances use the system and generate outcomes for secondary users.

We set out with the objective of establishing a “toolkit” which would evaluate performance of information technologies. We discovered that several challenges had to be overcome in order to enable implementation of the toolkit. Assessing information systems in a comprehensive fashion requires breaking down evaluation dimensions into numerous factors for which rigorous definitions must be provided in order to translate factors into metrics. Some factors lend themselves to quantitative metrics. For example, the number of distinct logins can be derived as a metric for the amount of use. However, many utilization factors are qualitative in nature and are therefore much harder to convert. Ease of use, for example, encompasses aspects such as ease of learning, ease of use after learning, usability, effectiveness, efficiency and error tolerance. In a case such as this, multiple metrics must be combined: the time (in hours) needed to train users, the time (in days) needed for users to become proficient at using the technology, the time (in minutes) in which the needed information is returned, and the time (in minutes) needed to recover from errors when they occur. Each of these metrics must then be assigned a proper data collection method. More importantly, scores must be attributed in order to produce the results of the evaluation. Not only does each score involve its own scale and algorithm but when several scores are produced they must be rank ordered to produce aggregate outcomes which are then compiled to form the overall result of the assessment. The foregoing provides only a brief overview, which focuses upon certain highlights. Greater detail will be provided in the detailed description which follows. The example given will focus upon a medical industry application.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a Flow Diagram of a Health System Evaluation Model.

FIG. 2 is a Flow Diagram of a Health System Evaluation Process.

FIG. 3 is a Health Information System Evaluation Toolkit.

FIG. 4 is a Graphic representation of a Toolkit Summary Dashboard.

FIG. 5 is a Graphic representation of a Toolkit Detailed Dashboard.

### DETAILED DESCRIPTION

The detailed analysis by which the essence was derived will now be described.

### 1. Problem

The solution that remediates the identified problem comprises four elements which have been to this point non-existent:

### 1.1. Comprehensive Evaluation Model

No universal model exists that describes the dimensions and benefits of health information systems and the relations among them to form the comprehensive framework necessary for the evaluation of health information systems. The created product for which a patent is sought provides such model which is described in Section 3.

### 1.2. Comprehensive Evaluation Process

No universal process exists that determines the actions required and the sequence in which they must be performed in order to produce the comprehensive evaluation of health information systems. The created product for which a patent is sought provides such a process, which is described in Section 4.

### 1.3. Comprehensive Evaluation Method

No universal method exists that determines the forms and procedures necessary to conduct the evaluation of health information systems. The created product for which a patent is sought provides such a method, which is described in Section 5.

### 1.4. Comprehensive Evaluation Toolkit

No universal set of tools exists to practically and effectively perform the evaluation of health information systems by:
Collecting and analyzing data on predetermined factors,
Following a predetermined and sequential series of steps and actions,
Using ad hoc procedures,
Producing quantified measures of systems' performance, effectiveness and efficiency, and
Generating recommendations to
   Increase health information systems' capacities,
   Optimize resource utilization,
   Increase return on investment,
   Prioritize and realize health information systems' improvements,
   Increase transparency and accountability through factual evidence, and
   Strengthen the strategic capability to control volatile internal and external environments.

The created product for which a patent is sought provides such a toolkit, which is described in Section 6.

### 2. Existing Solutions

Other than reference materials and theoretical guidelines, no solution is readily available to address the problem identified in Section 1 above.

### 1) Agency for Healthcare Research and Quality (AHRQ)

The Agency for Healthcare Research and Quality offers an online repository of resources such as surveys and measures to help design evaluation plans. Such materials are references only, and are called “a starting point” by the Agency itself. They include:
Samples of measures presented as a reference guide for the development of an evaluation plan—http://healthit.ahrq.gov/health-it-tools-and-resources/health-it-evaluation-measures-quick-reference-guides,
A compilation of publicly available surveys which can be used as reference for data collection—http://healthit.ahrq.gov/health-it-tools-and-resources/health-it-survey-compendium,
A guide to assist in the design of an evaluation plan. Even though it is called a “toolkit,” the guide does not provide the means to conduct an assessment but rather serves as reference material—http://healthit.ahrq.gov/health-it-tools-and-resources/health-it-evaluation-toolkit.

### 2) Healthcare Information and Management Systems Society (HIMSS)

The Healthcare Information and Management Systems Society offers an online library of case studies grouped into five categories called “Health IT Value STEPS™” to demonstrate the value of health information technology investments—http://www.himss.org/News/NewsDetail.aspx?ItemNumber=21536.

### 3) Research and Academia

Several researchers have proposed models for the evaluation of health information systems. These models are strictly theoretical and do not lend themselves to immediate practical application:
Kaplan B: 4 Cs model—http://www.ncbi.nlmn.nih.gov/pmc/articles/PMC61498/
Shaw NT: CHEATS models—http://www.ncbi.nlm.nih.gov/pubmed/11922936
DeLone and McLean: model of Information System Success—http://herbsleb.org/SCALEpapers/delone-information-1992.pdf.

Universities and think tanks have proposed evaluation frameworks which either have been limited to conceptual aspects or have never been commercialized, and are mainly restricted to academic environments:
RTI International: framework based on the CDC Framework for Program Evaluation used for public health programs—http://www.rti.org/pubs/rti_public_health_evaluation.pdf
HITECH Collaborative: consortium comprised of Weill Cornell Medical College at Cornell University, Columbia University, University of Rochester, and the State University of New York at Albany, created to assess New York State's health information technology and health information exchange initiatives—http://www.hitecny.org/.

### 4) Vendors and Consulting Firms

Vendors and consulting firms perform audits of existing information systems at the request of healthcare organizations. These investigations are not considered evaluations, as they are usually made in response to specific technical issues in systems initially developed and/or deployed by those vendors or consulting firms. Market analyses—often called evaluations—of available technical solutions are also produced by consulting firms to assist healthcare organizations in making purchasing decisions. These analyses cannot be considered evaluations as defined here, since they do not conform to the principles elaborated in the following sections and are conducted solely for purchasing purposes.

### 3. Health Information System Evaluation Model

The foundation of the evaluation toolkit is a model that represents the generic dimensions and net benefits to be considered when assessing a health information system.

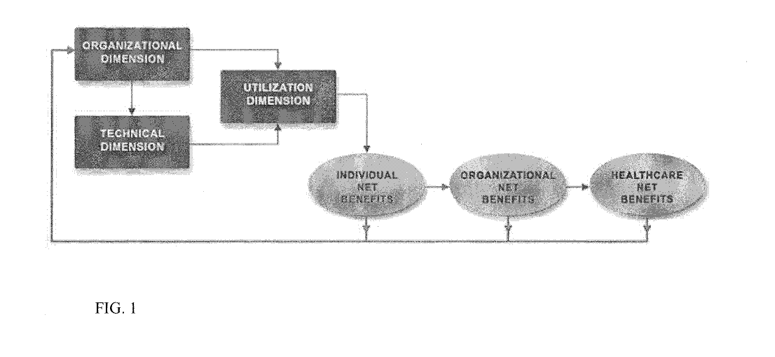

The model relies on three broad dimensions, as shown in FIG. 1:
Organizational: the broader context in which the technology exists and the key business determinants of its development and use;
Technical: the architectural and technological choices made to meet the business requirements and provide optimum use; and
Utilization: the use of the system in healthcare settings to address the purposes for which the technology was developed and/or implemented, i.e. financial, operational, medical, clinical, nursing and/or research purposes.

Net benefits are the positive outcome, or impact, of the technology and are also considered at three different levels:
Individual: healthcare professionals,
Organizational: healthcare organizations, and
Healthcare: entire healthcare systems.

Several relationships exist among dimensions:
The organizational dimension determines both the technical and utilization dimensions.
The utilization dimension is also directly determined by the technical dimension.
This three-dimensional complex then produces net benefits which have their own relationships. Impact at the organizational level is dependent on that realized on an individual basis and leads to net benefits on a larger scale, i.e. at the healthcare system level.
The model also accounts for a feedback loop from the impact levels to the organizational dimension.

### 4. Health Information System Evaluation Process

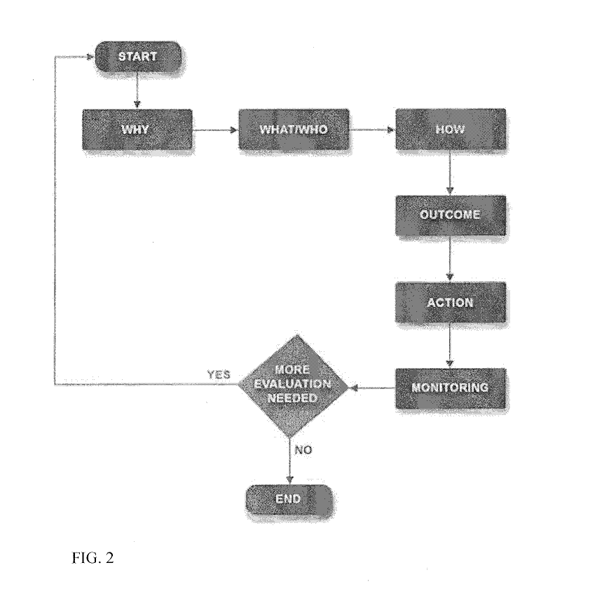

The second feature of the evaluation toolkit is a process that represents the steps and actions necessary to assess a health information system. FIG. 2 depicts the sequence as a flowchart.

### 4.1. Why?

The evaluation process starts with determining the objectives of the assessment by addressing two questions:
What do we expect from the evaluation?
What do we want to do with the results of the evaluation?

Answers to the first question vary based on the healthcare organization and the system under investigation. These include but are not limited to:
Optimizing system performance,
Optimizing system effectiveness,
Optimizing system utilization,
Increasing ROI,
Increasing adoption,
Informing future developments, and
Improving standing/competitive edge.

Answers to the second question equally vary and can range from reporting to stakeholders and demonstrating grant fulfillment, convincing late adopters, improving and/or further developing the technology, to demonstrating ROI and external dissemination such as publishing.

### 4.2. What/Who?

The next step of the evaluation process identifies which aspects of the system must be evaluated in order to meet the objectives previously established. Along with content, the system's stakeholders and the actors involved in the evaluation must also be identified.

Stakeholders include funders, executives and upper-level management personnel, IT staff, vendors and contractors, end users and those who directly and indirectly benefit from the system, from patients to public health officials.

Actors include developers for system testing and performance evaluation, project managers for financial and process assessment, users and domain experts for utilization evaluation, and third parties such as internal auditors and external experts.

The stage of the system development life cycle must also be factored in, i.e. under development, implemented, under long-term use, implemented or under long-term use with newer developments. This distinction refers to the binary nature of the evaluation, i.e. formative to inform the design process and summative to provide a retrospective account. Since evaluation should not be seen as a one-time event but rather as part of an overall improvement strategy, a baseline evaluation is recommended during the design phase and immediately after system implementation, followed by more detailed assessments when the system is fully in use.

### 4.3. How?

In this step, evaluation components and factors are selected along with the corresponding data collection method to meet the evaluation's requirements and objectives.

### 4.4. Outcome

The collected data is analyzed and a scoring system produces two types of scores:
An overall score for the evaluation, and
Individual scores for each of the investigated factors which are rank ordered and then assigned a relative weight through a weighting method.

Actionable recommendations are provided with the scores.

### 4.5. Action

It is left to the discretion of the healthcare organizations to choose which of the recommended interventions they will apply to act on the results provided in the outcome stage of the evaluation process.

### 4.6. Monitoring

To ensure continuous improvement and build the evaluation portfolio, monitoring of the interventions' impact should be conducted on an ongoing basis. When monitoring, the question should also be raised as to whether the system could benefit from additional evaluation. If the answer is yes, a new assessment process must be initiated; if no, the current evaluation process ends.

### 5. Health Information System Evaluation Methods

The third component of the evaluation toolkit is the method used to collect and analyze the data that will be treated by the toolkit (software) to generate the evaluation outcome and recommendations.

### 5.1. Data Collection

To perform the assessment of the information system, the toolkit collects data on a series of factors using quantitative and qualitative methods:
Quantitative method: surveys are conducted to gather quantitative data about the information system;
Qualitative methods: the following methods are used to collect data that provides an explanatory value to the metrics and cannot be gathered by the above-mentioned quantitative surveys:
   Reviewing the documentation pertaining to the management, development, implementation, and use of the technology;
   Reviewing the results of the system's testing and monitoring as well as performance, usage and helpdesk logs; and
   Focus groups and interviews with stakeholders and actors as defined in 4.2 above.

Combining these methods enables a twofold outcome:
The enumeration of measures such as frequencies and variances, and
The explanation and analysis of the “why” and “how” of such measures.

To conduct the evaluation across an entire organization, data must be collected from five subunits of personnel:
Subunit 1: management and technical staff,
Subunit 2: users working in a financial and operational capacity,
Subunit 3: users working in a medical, clinical and nursing capacity,
Subunit 4: users working in a research capacity, and
Subunit 5: external stakeholders and actors such as vendors, contractors, public health officials and patients

Each of these subunits includes executives as well as upper- and mid-level management staff.

### 5.1.1. Quantitative Method

The toolkit includes a series of built-in questionnaires that pose predefined questions to collect answers from a sample of users to produce quantitative descriptions of the system's characteristics, use, and impact. The toolkit uses an application that allows for a wide variety of display options and has built-in data analysis capability.

Quantitative survey instruments rely on four response categories:
Likert scale: (1) strongly disagree, (2) disagree, (3) somewhat disagree, (4) somewhat agree (5) agree, (6) strongly agree;
Two-item scale: yes/no, true/false;
Open-ended questions; and
Data entry of quantitative measures.

### 5.1.2. Qualitative Methods

Some of the factors involved in the evaluation cannot be reduced to discrete entities. Their explanatory value can only be obtained through in-depth analysis. Qualitative methods are better suited to address such factors and examine the dynamics of the processes under investigation rather than their static characteristics. Qualitative methods are therefore used to follow up on the questionnaires administered at an earlier stage. The following techniques are used:

### A. Documentation Review

This analysis provides detailed information on the setting under study. It also helps describe factors affecting system design, development, implementation and use. The following documents require particular attention:
Technical documents: development and implementation documentation;
Financial documents: cost variances and the results of the financial analyses performed;
Training programs and system documentation;
Agendas, announcements, and minutes; and
Administrative documents: proposals, progress reports, and formal studies.

### B. Systems Review

Key pieces of evidence are provided by the technical review of the system which should include:
System testing,
Performance monitoring,
Usage monitoring, and
Helpdesk logs.

### C. Interviews and Focus Groups

Through interviews and focus groups, various subunits of personnel are given the opportunity to express their views on and experiences with the technology. The toolkit provides a guide for each technique. The purpose of the guides is to facilitate the interviews and focus groups by offering directions on addressing the relevant factors, but at the same time also allowing the personnel involved to expand on their perception of the technology. Content generated by both techniques is audio recorded using a digital voice recorder with high acoustic quality and high capacity, and are transcribed for storage and analysis purposes.

### 5.2. Data Analysis

### 5.2.1. Quantitative Data Analysis

The toolkit adequately safeguards and stores the content of the completed surveys. Any anomaly and difficulty associated with dissemination and administration is accounted for. Since skipped and unanswered questions are automatically prevented by the application used to collect the data, the usual checks performed on traditional questionnaires are irrelevant. However, the overall coherence and consistency of the answers is confirmed. All questions including “other” as an option, open-ended questions, and scales are re-coded.

The first statistical measures are automatically produced by the application and include simple values such as frequency distributions, depending on the nature of the variables:
Nominal variables: number and percentage of personnel per category, mean, mode; and
Ordinal variables: the above measures as well as minimum, maximum, range, median and quartiles.

Moreover, the quantitative data analysis involves handling multiple answers and filtered questions, applying proper weighing mechanisms to compensate for over- and under-representation, performing statistical tests and procedures on individual and groups of variables, and producing graphical output.

### 5.2.2. Qualitative Data Analysis

With regard to the data collected through interviews and focus groups, the analysis is an iterative process in which data is continuously reviewed as it is collected. This process ends with the review of all previous conclusions and the clustering of data with similar meaning according to defined techniques. The recorded interviews and focus group sessions are transcribed and the transcripts are used to identify themes, develop categories, and establish similarities, differences and relationships within the data. The data obtained from other sources (documentation and system reviews) contribute to the comprehensive evaluation and is merged to produce an understanding of the technology as a whole, i.e. as a sum of its dimensions. The qualitative analysis provides an overall explanation of the health information system's use and impact, and searches the data for emerging patterns by:
Categorizing information;
Building matrices with the created categories;
Producing displays such as flowcharts and graphs;
Tabulating frequencies and exploring relationships; and
Situating information within a historical perspective.

### 6. Health Information System Evaluation Toolkit

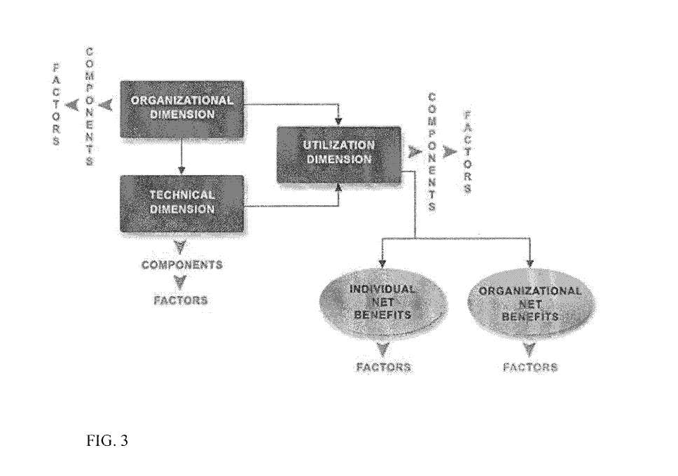

To translate the evaluation model, process and methods introduced earlier into their practical counterpart, i.e. the toolkit, the dimensions and net benefits must be divided into assessment components which, in turn, are broken down into finer grained elements, i.e. assessment factors against which the health information system is evaluated (see FIG. 3).

### 6.1. Toolkit Applicability and Customization

The evaluation model, process and methods introduced in Sections 3 to 5 are applicable to any health information system. Similarly, the toolkit's components and factors can be tailored to any health information system. By applying the toolkit to multiple systems, healthcare entities can acquire an evaluation portfolio relevant to their entire organization.

Customization also applies to the ways in which assessments are conducted. The toolkit can be used for full or partial evaluation. All dimensions can be assessed, single dimensions and components can be addressed, or a restricted set of specific factors can be selected. Similarly, the evaluation can be entirely outsourced, it can be entirely conducted internally or it can be performed through a combination of internal and external audits.

By definition, evaluation and impact assessments are performed with reference to baseline data relevant to the factors selected for the assessment. Since most healthcare organizations do not evaluate their information systems, such baseline data is currently unavailable. By enabling the systematic collection of data, the evaluation toolkit offers the means to develop dashboards and tracking mechanisms to establish such baseline data at the organizational level. The use of the toolkit by multiple organizations can, in turn, enable the establishment and adoption of standards and the dissemination of best practices through objective benchmarking across the entire healthcare sector.

Health data warehousing was chosen to demonstrate the toolkit modalities and features. For demonstration purposes, all subsequent sections will focus on this particular technology. A data warehouse is a “centrally managed and easily accessible copy of data collected in the transaction information systems of a corporation. These data are aggregated, organized, catalogued and structured to facilitate population-based queries, research and analysis” (Sanders, D, & Protti, D. (2008). Data warehouses in healthcare: Fundamental principles. Electronic Healthcare, 6(3), 1-16).

### 6.2. Toolkit Structure

As shown on FIG. 3, each dimension is first broken down into a set of evaluation components.

### 6.2.1. Dimension 1: Organizational Dimension

The organizational dimension of health data warehousing encompasses the broader context in which the technology exists and the key business determinants of the development and use of the technology. To effectively evaluate the health data warehouse, the dimension is broken down into five components:
Component 1A: Business needs. A data warehouse represents a considerable investment, and the delivery of data does not automatically enable its use. Healthcare organizations must ensure that business areas and data owners contribute to the warehouse effort, and that data is used to its best benefits.
Component 1B: Management support. Management support is a key determinant for overcoming political resistance, encouraging participation and conditioning user behaviour and acceptance. Management support is strengthened by the existence of a champion who promotes the project and provides information, material resources, and political support. This component also involves openness to opportunities and commitment to the changes required by process improvement for data warehousing to produce its intended results.
Component 1C: Resources. Beyond offering the ability to acquire the necessary equipment, sufficient resources are key for executing tasks and meeting project deadlines. The availability of sufficient resources also increases the likelihood of resolving organizational issues and provides the means to better communicate organizational commitments.
Component 1D: Users' needs. Identifying users' needs is critical for assessing how access to information can be best implemented to achieve business goals. On the other hand, by involving users in the data warehouse project, they are given opportunities to better understand the technology's potential, which makes them more likely to adopt the system.
Component 1E: User support. End-users have various backgrounds and their experience with databases varies as well. Not only should the data warehouse be useful to novice as well as advanced users, training and support programs should be established so that its use can be maximized.

### 6.2.2. Dimension 2: Technological Dimension

The technological dimension of health data warehousing comprises the architectural and technical choices that address the business requirements and the optimum treatment of the data necessary to the provision and use of analytics and reports. To enable the evaluation of the system, this dimension is divided into the following components:
Component 2A: Data and Use. Data quality has a direct impact on the analytics and reports produced by querying the health data warehouse. Since the latter makes data available by integrating an organization's source systems, the quality of such systems is equally paramount. From often incompatible medical standards to coding schemes, healthcare data presents unique challenges and requires careful translation. Moreover, data originates in multiple internal and external sources and must be provided in various formats.
Component 2B: Architectural choices. Appropriate architectural choices must be made in accordance with the organization's requirements and its need to cover administrative and financial functions as well as medical and research purposes. The choices apply to a range of technical aspects from data standards to metadata and system scalability.
Component 2C: Technological choices. Hardware, software, methods and programs must be available and of the best possible quality. Such tools are numerous and sophisticated, and their availability impacts the implementation and use of the health data warehouse.
Component 2D: Performance. High performance and high availability are closely associated. The data must be up-to-date and continuously available to guarantee a reliable and constant flow of information within the organization.

### 6.2.3. Dimension 3: Healthcare Utilization Dimension

The use of the system in healthcare settings serves financial, operational, medical, clinical, nursing, and research purposes. This dimension includes the following components which must be assessed to provide a comprehensive evaluation of the system:
Component 3A: Financial and operational utilization. From day-to-day operations to system-wide strategies, health data warehousing provides the analytics necessary to optimize processes, resource utilization and operating costs. The assessment should therefore address the use of the technology at the financial and operational level.
Component 3B: Medical/clinical/nursing utilization. By enabling the comparison and contrast of the causes, symptoms and treatments of specific illnesses, health data warehouses help make it possible to determine which course of action proves to be the most effective. As the technology offers the possibility of directly improving care and its delivery, the evaluation must address the use of the system for medical, clinical and nursing purposes.
Component 3C: Research utilization. Health data warehousing provides an explorative way to work with the data. It identifies trends and offers insight in areas that have not yet been investigated. It helps in formulating issues that have not yet been anticipated. It is therefore an ideal resource for research environments and the use of the system to this end must also be evaluated.

### 6.2.4. Net Benefits

Net benefits refer to the positive outcomes, or positive impact, of the data warehouse. Impacts must be assessed at three levels:
Individual, which concerns those professionals using the data warehouse in healthcare settings and is measured with metrics such as improved productivity and improved decision effectiveness, and
Organizational, which applies to healthcare organizations and involves measures such as the contribution to achieving the organization's goals and increased market share.
Healthcare, which concerns the healthcare system as a whole with outcome measures such as the impact on care, on patients' health and on healthcare costs.

### 6.3. Toolkit Factors and Data Treatments

As shown on FIG. 3, each component is further broken down into individual assessment factors.

### 6.3.1. Factors and Metrics

To effectively conduct the evaluation, components must be divided into their constituent assessment factors. Each of these individual factors must then be operationalized, i.e. converted into metrics to provide the means for collecting measures. The following examples show how a specific metric is arrived at for each of the toolkit's dimensions:
Organizational Dimension
   Component 1E: User Support
      Factor 1E-4: Helpdesk
         Metric: number of help tickets per month
Technological Dimension
   Component 2A: Data
      Factor 2A-1.3: Data Loading
         Metric: number of loading failures per month
Utilization Dimension
   Component 3A: Financial and Operational Utilization
      Factor 3A-1.1: Amount of Use
         Metric: number of distinct monthly logins

### 6.3.2. Data Treatments

The toolkit records data on the organization's profile, i.e. type of organization, number of beds, number of employees, type of data warehousing solution, and data warehousing budget. The profile is a key determinant of the toolkit's analytical process. In particular, the size of the organization determines the size, structure and use of the data warehouse.

Four generic categories have been established:
Category #1—small organization: number of employees <5,000
Category #2—medium organization: number of employees between 5,000 and 14,999
Category #3—large organization: number of employees between 15,000 and 24,999
Category #4—extra large organization: number of employees >25,000

The toolkit has a scoring system that records data on each factor under investigation. When applicable, expected average values, i.e. benchmarks, are established for individual factors. The data collected on these factors is recorded by the toolkit and compared against the benchmarks. When applicable, factors are compared across dimensions. In this case, the collected data is recorded by the toolkit and compared against values recorded for other factors.

The scoring system is based on a generic algorithm:
If the factor's measure <A, then score=X
If the factor's measure=A, then score=Y
If the factor's measure >A, then score=Z

Whenever a factor involves multiple metrics, a weighting mechanism is applied to reflect their relative importance. For example, factor F1 collects measures for 3 metrics to which the following weight distribution is applied:

### Metric F1.1=50%

### Metric F1.2=20%

### Metric F1.3=. 30%

Factors are the lowest level of the evaluation tree-structure, i.e. they are aggregated within the component they belong to, and these components are then aggregated to form the evaluation dimensions and net benefits. The toolset provides this aggregation through a ranking system that orders each factor and component by importance. For example, evaluating component C1 involves three factors which are rank ordered as follow:

### F1=3

### F2=2

### F3=1

Obtaining a lower score on factor F1 than factor F2 negatively impacts the assessment. More importantly, since it ranks first, F3 must obtain a minimum score of 50% to justify the investigation of the other two factors.

The same method applies to the aggregation of the components within a dimension. For example, dimension 1 involves three components which are rank ordered as follow:

### C1=2

### C2=1

### C3=3

Obtaining a lower aggregate score on C1 than C3 negatively impacts the overall dimension and a score inferior to 50% on component C2 will be flagged as an area on which remedial actions should be primarily focused.

The following sections demonstrate the practical application of the above principles. A scenario is constructed that involves a hypothetical healthcare organization to demonstrate the application of the metrics, scoring and ranking systems used in the toolkit. For this demonstration, the assessment is limited to the use of the technology and only involves 11 of the 150 factors included in the full toolkit. The factors used in the demonstration are:
Technical Evaluation:
   Available Applications (factor TE1.1 to TE1.3)
   Amount of Use (factor TE2.1 to TE2.5)
   Frequency and Duration of Use (factor TE3.1 to TE3.4)
Utilization Evaluation:
   Amount of Use (factor UE1.1 to UE1.8)
   Frequency and Duration of Use (factor UE2.1 to UE2.4)
   Motivation of Use (factor UE3.1 to UE3.8)
   Nature of Use (factor UE4.1 to UE4.7)
Organizational Evaluation:
   Business Needs Assessments (factor OE1.1 to OE1.4)
   Areas Targeted for Process Improvement and Cost Savings (factor OE2.1 to OE2.3)
Individual Net Benefits Evaluation:
   Increased Analytical Capability (factor INBE1.1 to INBE1.5)
Organizational Net Benefits Evaluation:
   Contribution to Organization's Goals and Mission (factor INBO1.1 to INBO1.3)

### 6.4. Organization Profile

The organization for which the data warehouse is assessed is a hospital that has 320 beds and 4,900 employees. It has an enterprise data warehouse that covers operational and clinical areas.

The budget for the data warehouse includes:
Capital budget: US$450,000
Operational budget: US$500.000
Number of FTEs: 4
Maintenance costs: US$200,000
Enhancement costs: US$300,000

The toolkit records this information through the following data elements:
Type of Organization
   Health System
   Hospital
   Medical Center
Numnber of Beds
Number of Employees
Type of data warehousing solution
   Operational
   Clinical
   Research
Budget of the data warehouse:
   Capital budget
   Operational budget
   Number of FTEs
   Maintenance costs
   Enhancement costs

### 6.5. Technical Evaluation

### 6.5.1. Evaluation Questions

This part of the assessment addresses the question: What are the front-end applications of the health data warehouse and to what use are they put? Front-end applications are pieces of software which deliver the final output of the data warehouse in the form of query results, dashboards and reports to end-users. This question is addressed from a technological perspective.

Three factors are used to address the main question through three sub-questions:
TE1 Available Applications: which front-end applications are used and what do they produce?
TE2 Amount of Use: how much are the front-end applications used?
TE3 Frequency and Duration of Use: how often are the front-end applications used, and when they are used, what is the duration of use?

### 6.5.2. Metrics

The following metrics are used to collect measures to address the above questions.
TE1
   TE1.1 Number of available applications, including their enumeration and corresponding vendor
   TE1.2 Number of dashboards produced to date, including their enumeration
   TE1.3 Number of reports produced to date, including their enumeration
TE2
   TE2.1 Number of individual licenses for each front-end application
   TE2.2 Number of dashboards downloaded per month over the past year for each type of dashboards listed in TE1.2
   TE2.3 Number of reports downloaded per quarter over the past year for each type of reports listed in TE1.3
   TE2.4 Number of queries run per month by primary users (as defined in [0011] on page 3) over the past year
   TE2.5 Number of queries run per month by secondary users over the past year
TE3
   TE3.1 Number of primary users' distinct logins per month over the past year for each front-end application
   TE3.2 Length of average session in minutes over the past year for primary users for each front-end application
   TE3.3 Number of secondary users' distinct logins per month over the past year for each front-end application
   TE3.4 Length of average secondary user session in minutes over the past year for each front-end tool

### 6.5.3. Data Collection Methods

A survey questionnaire is given to technical staff to collect the measures. The questions use the same labelling as the metrics and are:
TE1.1 How many front-end applications does the data warehouse use? Please list the applications with their corresponding vendor.
TE1.2 How many dashboards are currently produced which use data from the data warehouse? Please list the dashboards.
TE1.3 How many reports are currently produced which use data from the data warehouse? Please list the reports.
TE2.1 How many individual licenses are currently registered for each front-end application?
TE2.2 How many dashboards have been downloaded per month over the past year for each of the dashboards listed under question TE1.2?
TE2.3 How many reports have been downloaded per quarter over the past year for each of the reports listed under question TE1.3?
TE2.4 How many queries were run by primary users each month over the past year?
TE2.5 How many queries were run directly by secondary users each month over the past year?
TE3.1 How many distinct logins were recorded per month and per front-end application over the past year for primary users?
TE3.2 What was the length of the average session in minutes over the past year for primary users for each front-end application?
TE3.3 How many distinct logins were recorded per month and per front-end application over the past year for secondary users?
TE3.4 What was the length of the average session in minutes over the past year for secondary users for each front-end application?

On top of the above questionnaire, data on these factors is also collected from the organization's usage monitoring and tracking systems.

### 6.5.4. Scoring

The hospital has less than 5,000 employees and thus falls under category #1, small organization. The data warehouse includes two front-end tools, an application used to run queries (OO) and another used for data visualization (TT).

The scores for the metrics are processed as follow:

### Factor TE1—Available Applications

### TE1.1

If measure <2, then score=1/3 (less than 2 front-end applications)
If measure=2, then score=2/3 (2 front-end applications)
If measure >2, then score=3/3 (more than 2 front-end applications)
Measure=2, score=2/3

### Weight=50%

TE1.1 score=0.67×0.5=33.5%

### TE1.2.

If measure <5, then score=1/3 (less than 5 dashboards)
If measure between 5 and 10, then score=2/3 (between 5 and 10 dashboards)
If measure >10, then score=3/3 (more than 10 dashboards)
Measure=4, score=1/3

### Weight=25%

TE1.2 score=0.33×0.25=8.3%

### TE1.3.

If measure<10, then score=1/3 (less than 10 reports)
If measure between 10 and 20, then score=2/3 (between 10 and 20 reports)
If measure >20, then score=3/3 (more than 20 reports)
Measure=6, score=1/3

### Weight=25%

TE1.3 score=0.33×0.25=8.3%
Total TE1 score=33.5+8.3+8.3=50%

### Factor TE2—Amount of Use

### TE2.1A—OO

If measure <100, then score=1/3 (less than 100 licenses)
If measure between 100 and 250, then score=2/3 (between 100 and 250 licenses)
If measure >250, then score=3/3 (more than 250 licenses)
Measure=245, score=2/3

### Weight=40%

OO score=0.67×0.4=26.8%

### TE2.1B—TT

If measure <100, then score=1/3 (less than 100 licenses)
If measure between 100 and 250, then score=2/3 (between 100 and 250 licenses)
If measure >250, then score=3/3 (more than 250 licenses)
Measure=355, score=3/3

### Weight=40%

TT score=1×0.4=40%
TE2.1 score=(26.8+40.0)/2=33.4%

### TE2.2.

If measure <2,500, then score=1/3 (less than 5 dashboards downloaded once a month by 600 employees)
If measure between 2,500 and 10,000, then score=2/3 (up to 10 dashboards downloaded twice a month by 600 employees)
If measure >10,000, then score=3/3 (more than 10 dashboards downloaded twice a month by 600 employees)
Measure=3,500, score=2/3

### Weight=15%

TE2.2 score=0.67×0.15=10%

### TE2.3

If measure <5,000, then score=1/3 (less than 10 reports downloaded quarterly by 600 employees)
If measure between 5,000 and 10,000, then score=2/3 (up to 20 reports downloaded quarterly by 600 employees)
If measure >10,000, then score=3/3 (more than 20 reports downloaded quarterly by 600 employees)
Measure=6,500, score=2/3

### Weight=15%

TE2.3 score=0.67×0.15=10%

### TE2.4

If measure <10, then score=1/3 (less than 10 primary users performing 1 query or more per month)
If measure between 10 and 30, then score=2/3 (up to 30 primary users performing 1 query or more per month)
If measure >30, then score=3/3 (more than 30 primary users performing 1 query or more per month)
Measure=15, score=2/3

### Weight=15%

TE2.4 score=0.67×0.15=10%

### TE2.5

If measure <10, then score=1/3 (less than 10 secondary users performing 1 query or more per month)
If measure between 10 and 30, then score=2/3 (up to 30 secondary users performing 1 query or more per month)
If measure >30, then score=3/3 (more than 30 secondary users performing 1 query or more per month)
Measure=8, score=1/3

### Weight=15%

TE2.5 score=0.33×0.15=5%
Total TE2 score=33.4+10+10+10+5=: 68%

### Factor TE3—Frequency and Duration of Use

### TE3.1A—OO

If measure <300, then score=1/3 (less than 300 distinct logins per month)
If measure between 300 and 600, then score=2/3 (up to 300 distinct logins per month)
If measure >600, then score=3/3 (more than 300 distinct logins per month)
Measure=450, score==2/3

### Weight=20%

OO score=0.67×0.2=13.4%

### TE3.1B—TT

If measure <300, then score=1/3 (less than 300 distinct logins per month)
If measure between 300 and 600, then score=2/3 (up to 300 distinct logins per month)
If measure >600, then score=3/3 (more than 300 distinct logins per month)
Measure=650, score=3/3

### Weight=20%

TT score=1×0.2=20%
TE3.1 score=(13.4+20)/2=16.7%

### TE3.2A—OO

If measure <120, then score=1/3 (primary users' average session is less than 120 minutes)
If measure between 120 and 240, then score=2/3 (primary users' average session is between 120 and 240 minutes)
If measure >210, then score=3/3 (primary users' average session is more than 240 minutes)
Measure=250, score=3/3

### Weight=30%

OO score=1×0.3=30%

### TE3.2B—TT

If measure <120, then score=1/3 (primary users' average session is less than 120 minutes)
If measure between 120 and 240, then score=2/3 (primary users' average session is between 120 and 240 minutes)
If measure >240, then score=3/3 (primary users' average session is more than 240 minutes)
Measure=320, score=3/3

### Weight=30%

TT score=1×0.3=30%
TE3.2 score=(30+30)/2=30%/6

### TE3.3A—OO

If measure <200, then score=1/3 (less than 200 distinct logins per month)
If measure between 200 and 400, then score=2/3 (up to 200 distinct logins per month)
If measure >400, then score=3/3 (more than 200 distinct logins per month)
Measure=290, score=2/3

### Weight=20%

OO score=0.67×0.2=13.4%

### TE3.3B—TT

If measure <200, then score=1/3 (less than 200 distinct logins per month)
If measure between 200 and 400, then score=2/3 (up to 200 distinct logins per month)
If measure >400, then score=3/3 (more than 200 distinct logins per month)
Measure=570, score=3/3

### Weight=20%

TT score=1×0.2=20%
TE3.3 score=(13.4+20)/2=16.7%

### TE3.4A—OO

If measure <120, then score=1/3 (secondary users' average session is less than 120 minutes)
If measure between 120 and 240, then score=23 (secondary users' average session is between 120 and 240 minutes)
If measure >210, then score=3/3 (secondary users' average session is more than 240 minutes)
Measure=80, score=1/3

### Weight=30%

OO score=0.33×0.3=10%

### TE3.4B—TT

If measure <120, then score=1/3 (secondary users' average session is less than 120 minutes)
If measure between 120 and 240, then score=2/3 (secondary users' average session is between 120 and 240 minutes)
If measure >240, then score=3/3 (secondary users' average session is more than 240 minutes)
Measure=210, score=2/3

### Weight=30%

TT score=0.67×0.3=20%
TE3.4 score=(10+20)/2=15%
Total TE3 score=16.7+30+16.7+15=78%

### 6.5.5. Ranking

The relative importance of each factor is as follow:
1) TE1=50%
2) TE2=68%
3) TE3==78%

Since the score of the most important factor (TE1) is at the 50% mark, it does not preclude the investigation of the other two factors. However, because it is so close to the threshold, remedial actions will focus more on this factor. They will also highlight the fact that the higher score is obtained on the factor which ranks the lowest in importance.

### 6.5.6. Additional Quantitative Data Analysis

Besides the numeric values described above, the toolkit computes additional ratios which help further analyze from a technological standpoint the proportion of use among applications, among dashboards, and among reports.

### Factor TE2

Proportion of licenses per application
OO: 245/600=41%
IT: 355/600=59%

Proportion of queries per primary and secondary users
Primary users: 15/23=65%
Secondary users: 8/23=35%

Proportion of use per dashboard
Accounts Receivable/Payable: 22%
Operational Status: 16%
Doctors performance: 28%
Patients metrics: 34%

Proportion of use per report
Meaningful Use/Health Information Exchange Progress Report: 26%
Healthcare Payment Reform Report: 21%
Acute Care Report: 6%
Ambulatory Surgery Report: 7%
Uncompensated Care Report: 18%
Finance and Utilization Trends: 12%

### Factor TE3

Proportion of distinct logins per application
OO: 740/1,960=38%
TT: 1,220/1,960=62%

Ratio of primary users to secondary users' distinct logins
OO: 450/290=1.6
TT: 650/570=1.1

Ratio of primary users to secondary users' session's length
OO: 250/80=3.1
TT: 320/460=0.70

Preliminary observation:
One dashboard is considerably less used than the others;
Reports are overall less used than dashboards and this is particularly true for two of them;
Considering the fact that TT is a visualization software mainly intended for secondary users, its ratio of distinct logins is abnormally high but somewhat

compensated by the average length of the sessions recorded for these users.

The next evaluation focuses on utilization from an end-users' perspective. This enables a correlation of the quantitative values obtained from the technological evaluation with qualitative data gathered through users' interviews.

### 6.6. Utilization Evaluation

### 6.6.1. Evaluation Questions

This part of the assessment addresses the question: How are the front-end applications of the health data warehouse utilized? The use of the front-end applications previously assessed from a technological standpoint is now evaluated from a users' perspective.

Four factors are used to address the main question through four sub-questions:
UE1. Amount of Use: how much do primary and secondary users utilize the front-end tools?
UE2. Frequency and Duration of Use: how often do primary and secondary users utilize the front-end applications, and when they do, what is the duration of use?
UE3. Motivation of Use: what incites primary and secondary users to utilize the front-end applications?
UE4. Nature of Use: how do primary and secondary users utilize the front-end

applications?

### 6.6.2. Metrics

The following metrics are used to collect measures to address the above questions.
UE1
   UE1.1. Number of front-end applications used, including their enumeration
   UE1.2. Total number of users per application
   UE1.3. Number of primary users per application
   UE1.4. Number of secondary users per application
   UE1.5. Number of dashboards downloaded per month over the past year, including their enumeration
   UE1.6. Number of reports downloaded per quarter over the past year, including their enumeration
   UE1.7. Number of queries run by primary users per month over the past year
   UE1.8. Number of queries run by secondary users per month over the past year
UE2
   UE2.1. Number of primary users' sessions per month over the past year for each front-end application
   UE2.2. Length of average primary user session in minutes over the past year for each front-end application
   UE2.3. Number of secondary users' sessions per month over the past year for each front-end application
   EU2.4. Length of average secondary user session in minutes over the past year for each front-end application
UE3
   UE3.1. Needs addressed by the front-end applications and reasons why primary users utilize them
   UE3.2. Incentives for primary users to use the front-end applications
   UE3.3. Time commitment made by primary users to utilize the front-end applications
   UE3.4. Level of effort expended by primary users to utilize the front-end applications
   UE3.5. Needs addressed by the front-end applications and reasons why secondary users utilize them
   UE3.6. Incentives for secondary users to utilize the front-end applications
   UE3.7. Time commitment made by secondary users to utilize the front-end applications
   UE3.8. Level of effort expended by secondary users to utilize the front-end

applications
UE4
   UE4.1. Use of the front-end applications by primary users in a recurring vs. sporadic fashion
   UE4.2. Use of the front-end applications by primary users in a routine vs. exploratory fashion
   UE4.3. Use of the front-end applications by primary users in a broad vs. ad hoc fashion
   UE4.4. Use of the front-end applications by secondary users in a recurring vs. sporadic fashion
   UE4.5. Use of the front-end applications by secondary users in a direct (themselves) vs. chauffeured (through someone else) fashion
   UE4.6. Use of the front-end applications by secondary users in a routine vs. exploratory fashion
   UE4.7. Use of the front-end applications by secondary users in a broad vs. ad hoc fashion

### 6.6.3. Data Collection Methods

A survey questionnaire is given to a statistically representative sample of primary users and secondary users to collect measures on the first two factors. The questions use the same labelling as the metrics and are:
UE1.1. How many front-end applications do you use? Please list these tools.
UE1.2/3/4. Do you consider yourself a “primary user” who uses the front-end applications for others or do you consider yourself a secondary user?
UE1.5. On average over the past year, how many dashboards did you download per month? Please list these dashboards.
UE1.6. On average over the past year, how many reports did you download per quarter? Please list these reports.
UE1.7/8. On average over the past year, how many queries did you run per month?
UE2.1/3. On average over the past year, how many times per month did you use each front-end application of the data warehouse (OO, TT, RR)?
UE2.2/4. On average over the past year, how much time did you spend whenever you used the front-ends application of the data warehouse (OO, TT, RR)?

The third (motivation of use) and fourth (nature of use) factors are investigated via interviews or focus groups. A statistically representative sample of primary and secondary users is selected to analyze these factors. The interviews and focus groups' questions use the same labelling as the metrics and are:
UE3.1/5. For which purposes and reasons do you use the front-end applications of the data warehouse? What are your goals and which needs do you expect to be addressed?
UE3.2/6. Are there incentives at the departmental and/or organizational level for you to use the front-end applications of the data warehouse?
UE3.3/7. On average, how much time do you devote each month to the use of the front-end applications?
UE3.4/8. In your opinion, have you achieved an optimal use of the front-end applications? If not, what would enable you to use the front-end applications in an optimal manner?
UE4.1/4. Do you use the front-end applications of the data warehouse at regular or irregular intervals?
UE4.2/6. When you use the front-end applications of the data warehouse, do you follow similar patterns and procedures or is it part of a discovery process?
UE4.3/7. Do you use the front-end applications of the data warehouse to investigate broad concepts or narrow and well delineated issues?
UE4.5. Do you personally use the front-end applications of the data warehouse or do you instruct someone to obtain results for you?

### 6.6.4. Scoring

The data collected from users for the first (amount of use) and second (frequency and duration of use) factors is compared with the technical data recorded earlier for the same factors. The scoring reflects the equivalence and/or discrepancies between these two types of measures. The scores for the metrics are processed as follow:

### Factor UE1—Amount of Use

### UE1.1

If measure <TE1.1, then score=1/3
If measure=TE1.1, then score=3/3
If measure >TE1.1, then score=1.5/3
Measure=3, score=1.5/3

### Weight=30%

UE1.1 score=0.50×0.30=15%

### UE1.2A—OO

If measure <TE2.1A, then score=1/3
If measure=TE2.1A, then score=3/3
If measure >TE2.1A, then score=1.5/3
Measure=200, score=1/3

### Weight=15%

OO score=0.33×0.15=5%

### UE1.2B—TT

If measure <TE2.1 B, then score=1/3
If measure=TE2.1 B, then score=3/3
If measure >TE2.1 B, then score=1.5/3
Measure=400, score=1.5/3

### Weight=15%

TT score=0.50×0.15=7.5%
UE2.1 score=(5+7.5)/2=6.3%

### UE1.5

If measure <TE2.2, then score=1/3
If measure=TE2.2, then score=3/3
If measure >TE2.2, then score=1.5/3
Measure=3,100, score=1/3

### Weight=10%

UE1.5 score=0.33×0.10=3%

### UE1.6

If measure <TE2.3, then score=1/3
If measure=TE2.3, then score=3/3
If measure >TE2.3, then score=1.5/3
Measure=6,800, score=1/3

### Weight=10%

UE1.6 score=0.50×0.10=5%

### UE1.7

If measure <TE2.4, then score=1/3
If measure=TE2.4, then score=3/3
If measure >TE2.4, then score=1.5/3
Measure=25, score=1.5/3

### Weight=10%

UE1.7 score=0.50×0.10=5%

### UE1.8

If measure <TE2.5, then score=1/3
If measure=TE2.5, then score=3/3
If measure >TE2.5, then score=1.5/3
Measure=16, score=1/3

### Weight=10%

UE1.8 score=0.50×0.10=5%
Total UE1 score=15+6.3+3+5+5.4+5=39%

### Factor UE2—Frequency and Duration of Use

### UE2.1A—OO

If measure <TE3.1A, then score=1/3
If measure=TE3.1A, then score=3/3
If measure >TE3.1A, then score=1.5/3
Measure=350, score=1/3

### Weight=30%

OO score=0.33×0.30=10%

### UEC2.1B—TT

If measure <TE3.1 B, then score=1/3
If measure=TE3.1 B, then score=3/3
If measure >TE3.1B, then score=1.5/3
Measure=700, score=1.5/3

### Weight=30%

TT score=0.50×0.30=15%
UE2.1 score=(10+15)/2=12.5%

### UE2.2A—OO

If measure <TE3.2A, then score=1/3
If measure=TE3.2A, then score=3/3
If measure >TE3.2A, then score=1.5/3
Measure=180, score=1/3

### Weight=20%

OO score=0.33×0.20=7%

### UE2.2B—TT

If measure <TE3.2B, then score=1/3
If measure=TE3.2B, then score=3/3
If measure >TE3.2B, then score=1.5/3
Measure=240, score=1/3

### Weight=20%

TT score=0.33×0.20=7%
UE2.2 score=(7+7)/2=7%

### UE2.3A—OO

If measure <TE3.3A, then score=1/3
If measure=TE3.3A, then score=3/3
If measure >TE3.3A, then score=1.5/3
Measure=280, score=1/3

### Weight=30%

OO score=0.33×0.30=10%

### UE2.3B—TT

If measure <TE3.3B, then score=1/3
If measure=TE3.3B, then score=3/3
If measure >TE3.3B, then score=1.5/3
Measure=600, score=1.5/3

### Weight=30%

TT score=0.50×0.30=15%
UE2.3 score=(10+15)/2=12.5%

### UE2.4A—OO

If measure <TE3.4A, then score=1/3
If measure=TE3.4A, then score=3/3
If measure >TE3.4A, then score=1.5/3
Measure=60, score=1/3

### Weight=20%

OO score=0.33×0.20=7%

### UE2.4B—TT

If measure <TE3.4B, then score=1/3
If measure=TE3.4B, then score=3/3
If measure >TE3.4B, then score=1.5/3
Measure=180, score=1/3

### Weight=20%

TT score=0.33×0.20=7%
UE2.4 score=(7+7)/2=7%
Total UE2 score=12.5+7+12.5+7=39%

### Factor UE3—Motivation of Use

The data collected for the metrics used to investigate the motivation of use is qualitative in nature and does not lend itself to quantitative analysis. Instead, the information gathered through interviews and focus groups is analyzed using the methods described in Section 5.2.2. For the purpose of this demonstration, the content analysis is said to reveal a high level of motivation characterized by the following scores:

UE3.1 score: 12%
UE3.2 score: 8%
UE3.3 score: 12%
UE3.4 score: 12%
UE3.5 score: 12%
UE3.6 score: 12%
UE3.7 score: 7%
UE3.8 score: 7%
Total UE3 score=82%

### Factor UE4—Nature of Use

Like motivation, the nature of use is a factor evaluated through interviews and focus groups, and the collected data is also qualitative in nature. Unlike the results of the previous factors, those obtained from the analysis of the nature of use do not lend themselves to scoring. Instead, they add an explanatory value to the evaluation and serve as a reference against which the results of the organizational assessment are compared. For the purpose of this demonstration, the nature of use is found to be:

UE4.1: recurring 20%, sporadic 80%
UE4.2: routine 30%, exploratory 70%
UE4.3: broad 40%, ad hoc 60%
UE4.4: recurring 80%, sporadic 20%
UE4.5: direct 10%, chauffeured 90%
UE4.6: routine 70%, exploratory 30%
UE4.7: broad 30%, ad hoc 70%

### 6.6.5. Ranking

The relative importance of each factor is:
1) UE3=82%
2) UE2=39%
3) UE1=39%

Unlike the previous technical dimension, the assessment of utilization produces the highest score on the factor which ranks the highest in importance, i.e. the third factor. The scores of the first and second factors are below 50% which is indicative of the discrepancies found with the technological dimension. However, since they rank lower in importance, they do not preclude the rest of the evaluation. Since the fourth factor does not lend itself to an overall score and has explanatory value, it is not taken into consideration in the ranking system.

### 6.6.6. Additional Quantitative Data Analysis

Besides the numeric values described above, the toolkit computes additional ratios which help further analyze from a user standpoint the proportion of use among applications, among dashboards, and among reports.

### Factor UE1

Proportion of users per application
OO: 200/640=31%
TT: 400/640=63%
RR: 40/640=6%

Proportion of primary users per application
OO: 60/200=30%
TI: 120/400=30%
RR: 40/40=100%

Proportion of secondary users per application
OO: 140/200=70%
TT: 280/400=70%
RR: 0/40=0%

Ratio of primary to secondary users per application
OO: 60/140=0.4
TT: 120/280=0.4

Proportion of use per dashboard
Accounts Receivable/Payable: 28%
Operational status: 5%
Doctors' performance: 32%
Patients' metrics: 35%

Proportion of use per report
Meaningful Use/Health Information Exchange Progress Report: 32%
Healthcare Payment Reform Report: 26%
Acute Care Report: 3%
Ambulatory Surgery Report: 4%
Uncompensated Care Report: 21%
Finance and Utilization Trends: 14%

Proportion of queries per primary and secondary users
Primary users: 25/41=61%
Secondary users: 16/41=39%

Factor UE2

Proportion of sessions per application
OO: 630/1,930=33%
TT: 1,300/1,930=67%

Ratio of primary users to secondary users' sessions
OO: 350/280=1.3
TT: 700/600=1.2

Ratio of primary users to secondary users' session's length
OO: 180/60=3
TT: 240/180=1.3

Preliminary observation:
One front-end tool, an open-source statistical software RR, is utilized by primary users but not accounted for by the data warehousing team in the assessment of the technical dimension;
There are fewer OO users than there are licenses registered for the software;
There are more TT users than there are licenses registered for the software;
Discrepancies are found between the number of dashboards and reports recorded as downloaded and the number of dashboards and reports directly designated by users as useful;
Discrepancies are also found in the frequency and duration of use between what is reported by users and what is recorded by the data warehousing team.

The next evaluation focuses on the organizational dimension of use, i.e. how users' needs have been taken into account in the development of the data warehouse and which business goals the technology is meant to address. This enables a correlation of the qualitative data previously obtained on the motivation of use with the data gathered on the purposes and goals served by the technology at the organizational level.

### 6.7. Organizational Evaluation

### 6.7.1. Evaluation Questions

This part of the assessment addresses the question: Were business needs properly established?

The use of the front-end tools previously assessed from a technological and users' standpoint is now evaluated from an organizational perspective.

Two factors are used to address the main question through two sub-questions:
OE1. Business needs: Have business needs and objectives been properly identified? Is there any gap in the analysis that was performed?
OE2. Areas targeted for process improvement and cost savings: What are the areas in which the data warehouse's front-end applications are used to improve processes and reduce costs?

### 6.7.2. Metrics

The following metrics are used to collect measures to address the above questions.
OE1
   OE1.1. Identification of business drivers and objectives
   OE1.2. Completeness and alignment of business requirements with business drivers
   OE1.3. Identification of information needs, including amount and frequency of reporting and analytical needs
   OE1.4. Identification of users' needs, including motivation and nature of use
OE2
   OE2.1. Organization-wide process improvement and cost saving initiatives
   OE2.2. Financial/operational process improvement and cost saving initiatives
   OE2.3. Medical/clinical/nursing process improvement and cost saving initiatives

### 6.7.3. Data Collection Methods

Document review is used to collect measures on the first factor (business needs). All applicable project management documents are reviewed to analyze both how business requirements, information and users' needs were accounted for and their relationship with the known business drivers and objectives of the data warehouse.

The second factor (areas targeted for process improvement and cost savings) is investigated via interviews of or focus groups with operational/financial, medical, clinical and nursing staff working in an upper-level management capacity. The interviews and focus groups' guides use the same labelling as the metrics and include the following questions:
OE2.1. Are you aware of organization-wide initiatives targeting process improvement and cost savings? If yes, what are they?
OE2.2. Are there initiatives currently targeting process improvement and cost savings from an operational/financial perspective? If yes, what are they?
OE2.3. Are there initiatives currently targeting process improvement and cost savings from a medical/clinical/nursing perspective? If yes, what are they?

### 6.7.4. Scoring

### Factor OE1—Business Needs

The data collected for the metrics used to investigate how business needs have been accounted for is qualitative in nature and does not lend itself to quantitative analysis.

Instead, the information gathered through document review is analyzed using the methods described in Section 5.2.2. The scores for the metrics are calculated as follow:

OE1.1.—Business drivers

If business drivers have not been identified, then score=0/3
If business drivers have been poorly identified, then score=1/3
If business drivers have been partially identified, then score=2/3
If business divers have been properly identified, then score=3/3
Measure=business drivers have been partially identified, score=2/3

### Weight=25%

OE1.1. score=0.66×0.25=16.5%

### OE1.2A.—Completeness of Business Requirements

If business requirements are largely undefined, then score=0/3
If business requirements are mostly incomplete, then score=1/3
If business requirements are somewhat complete, then score=2/3
If business requirements are complete, then score=3/3
Measure=business requirements are mostly incomplete, score=1/3

### Weight=12.5%

Completeness score=0.33×0.125=4.13%
OE1.2B.—Alignment of Business Requirements with Business Drivers
If business requirements are not aligned with business drivers, then score==0/3
If business requirements are poorly aligned with business drivers, then score=1/3
If business requirements are partially aligned with business drivers, then score=2/3
If business requirements are well aligned with business drivers, then score=3/3
Measure=business requirements are partially aligned with business drivers, score=2/3

### Weight=12.5%

Alignment score=0.66×0.125=8.25%
OE1.2. score=(4.13+8.25)/2=6.2%

### OE1.3.—Information Needs

If information needs have not been identified, then score=0/3
If information needs have been poorly identified, then score=1/3
If information needs have been partially identified, then score=2/3
If information needs have been properly identified, then score=3/3
Measure=information needs have been partially identified, score=2/3

### Weight=25%

OE1.3. score=0.66×0.25=16.5%

### OE1.4.—Users' Needs

If users' needs have not been identified, then score=0/3
If users' needs have been poorly identified, then score=1/3
If users' needs have been partially identified, then score=2/3
If users' needs have been properly identified, then score=3/3
Measure=users' needs have been partially identified, score=2/3

### Weight=25%

OE1.4. score=0.66×0.25=16.5%
Total OE1 score=16.5+6.2+16.5+16.5=55.7%

### Factor OE2—Areas Targeted for Process Improvement and Cost Savings

Factor OE2 is evaluated through interviews and focus groups. The collected data is thus qualitative and adds an explanatory value to the evaluation. Like other qualitative data, it serves as a reference against which the results of other assessments (in this case the organizational net benefits evaluation) are compared. The scores for the metrics are processed as follow:

### OE2.1.—Organization-Wide Initiatives

If initiatives have not been identified, then score=0/3
If initiatives have been poorly identified, then score=1/3
If initiatives have been partially identified, then score=2/3
If initiatives have been properly identified, then score=3/3
Measure=initiatives have been partially identified, score=2/3

### Weight=30%

OE2.1. score=0.66×0.3=19.8%

### OE2.2.—Operational/Financial Initiatives

If initiatives have not been identified, then score=0/3
If initiatives have been poorly identified, then score=1/3
If initiatives have been partially identified, then score=2/3
If initiatives have been properly identified, then score=3/3
Measure=operational/financial initiatives have partially well identified, score=2/3

### Weight=35%

OE2.2. score=0.66×0.35=23.1%

### OE2.3.—Medical/Clinical/Nursing Initiatives

If initiatives have not been identified, then score=0/3
If initiatives have been poorly identified, then score=1/3
If initiatives have been partially identified, then score=2/3
If initiatives have been properly identified, then score=3/3
Measure=Medical/clinical/nursing initiatives have been partially identified, score=2/3

### Weight=35%

OE2.2. score=0.66×0.35=23.1%
Total OE2 score=19.8+23.1+23.1=66%

### 6.7.5. Ranking

The relative importance of each factor is:
1) OE2=66%
2) OE1=56%

The assessment of the organizational dimension produces the highest score on the factor which ranks the highest in importance, i.e. the second factor, and the score of the first factor is above 50%.

### 6.7.6. Additional Quantitative Data Analysis

The toolkit computes additional analyses for the organizational assessment. Instead of ratios, these additional analyses consist of correlations. The scores on business drivers and business requirements are compared with those previously obtained on utilization. Similarly, the scores on information needs and users' needs are compared with the utilization scores obtained on the motivation and nature of use. Lastly, the scores on identification of areas targeted for process improvement and cost savings are compared with the organization's financial results.

Preliminary observation:
Information and users' needs are sufficiently identified which correlates with the high scores obtained on the motivation and nature of use;
Business drivers are partially identified but this is compensated by the fact that process improvement and cost savings initiatives are well delineated across the organization which correlates with the presence of incentives at the users level;
Business requirements are incomplete despite a clear definition by users of the nature of use.

The next assessments focus on net benefits from an individual and organizational standpoint.

This enables impact evaluation and a correlation with the qualitative data obtained on the utilization and organizational dimensions.

### 6.8. Individual Net Benefits Evaluation

### 6.8.1. Evaluation Questions

This part of the assessment addresses the question: What are the net benefits (positive impact) of the health data warehouse's front-end applications at the individual staff level? After assessing the use of the front-end applications from the standpoints of technology, utilization and organization, the impact of the technology is evaluated from the perspective of the individual staff level. For the purpose of this demonstration, a single factor is used to address this question:
INBE1. Increased Analytical Capability: Has the capability of users to analyze issues been increased as a result of using the health data warehouse?

### 6.8.2. Metrics

The following metrics are used to collect measures to address the above question.
INBE1.1. Increased ability to correctly diagnose known issues
INBE1.2. Increased ability to generate complete analyses
INBE1.3. Increased ability to discover unknown issues
INBE1.4. Increased ability to generate alternatives
INBE1.5. Increased ability to develop appropriate solutions

### 6.8.3. Data Collection Methods

To collect measures on the above factor, a survey questionnaire is given to a statistically representative sample of users working in financial, medical, clinical and nursing areas in an upper-level management capacity. The questions use the same labelling as the metrics.

Using the scale where 1 indicates that you strongly disagree and 6 indicates
that you strongly agree, please rate the following statements:

| | Strongly | | Somewhat | Somewhat | | Strongly |
|---|---|---|---|---|---|---|
| | Disagree | Disagree | Disagree | Agree | Agree | Agree |
| INBE1.1 The use of the data warehouse's frong-end tools | 1 | 2 | 3 | 4 | 5 | 6 |
| has increased my ability to correctly diagnose known issues. | | | | | | |
| INBE1.2 The use of the data warehouse has increased my | 1 | 2 | 3 | 4 | 5 | 6 |
| ability to generate complete analyses. | | | | | | |
| INBE1.3 The use of the data warehouse's front-end tools | 1 | 2 | 3 | 4 | 5 | 6 |
| has increased my ability to discover unknown issues. | | | | | | |
| INBE1.4 The use of the data warehouse's front-end tools | 1 | 2 | 3 | 4 | 5 | 6 |
| has increased my ability to generate alternatives. | | | | | | |
| INBE1.5 The use of the data warehouse's front-end tools | 1 | 2 | 3 | 4 | 5 | 6 |
| has increased my ability to develop appropriate solutions. | | | | | | |

Additionally, interviews of or focus groups with the same staff members who took the survey can be conducted to give respondents the opportunity to expand on these statements.

### 6.8.4. Scoring

The following scores are attributed to the scale's items:
Strongly disagree: −5;
Disagree: −3;
Somewhat disagree: −1;
Somewhat agree: 1;
Agree: 3; and
Strongly agree: 5

Individual scores are assessed to identify patterns in responses and potential biases. The mean score of all items constitute the overall score. A positive score is interpreted as an increase in analytical capability and a negative score as a lack of improvement in analytical capability:
Scores of 4 to 5 indicate a considerable increase;
Scores of 2 to 3.99 indicate a moderate to significant increase;
Scores of 0.5 to 1.99 indicate a moderate increase;
Scores of −0.5 to 0.49 indicate a limited increase; and
Scores lower than −0.5 indicate a lack of improvement.

For the purpose of this demonstration, individual net benefits are said to be characterized by the following scores:

| | Strongly | | Somewhat | Somewhat | | Strongly | |
|---|---|---|---|---|---|---|---|
| | Disagree | Disagree | Disagree | Agree | Agree | Agree | Total Score |
| INBE1.1 | 0 | 0 | 0 | 70/70 | 120/360 | 410/2050 | 2,480:600 = 4.1 |
| INBE1.2 | 0 | 0 | 0 | 20/20 | 80/240 | 500/2,500 | 2,760:600 = 4.6 |
| INBE1.3 | 0 | 0 | 0 | 0 | 220/660 | 380/1,900 | 2,560:600 = 4.3 |
| INBE1.4 | 0 | 180/−540 | 180/−180 | 160/160 | 80/160 | 0 | −400:600 = −1 |
| INBE1.5 | 0 | 120/−360 | 160/−160 | 240/240 | 80/240 | 0 | −40:600 = −0.1 |
| Total | | | | | | | 2.4 |

With an overall score of 2.4, the data warehouse's front-end applications enable a moderate to significant increase in analytical capability for its users. This score is on the lower end of its category because 2 of the 5 sub-factors are in the negative range with a lack of improvement in generating alternatives and only a limited improvement in developing appropriate solutions. However, the increase in analytical capability is considerable when it applies to diagnosing known issues, generating complete analyses and discovering unknown issues.

### 6.8.5. Ranking

This demonstration involves a single factor for the assessment of individual net benefits. However the chosen factor ranks first in this category and requires a score of 2 or above. Since the obtained score is 2.4, the ranking requirement is satisfied.

### 6.8.6. Additional Quantitative Data Analysis

The toolkit computes additional analyses for the individual net benefits assessment. Instead of ratios, these additional analyses consist of correlations. The scores on the ability to diagnose issues, generate complete analyses, discover unknown issues, generate alternatives and develop appropriate solutions are compared with the scores previously obtained on utilization and with the financial results generated by the initiatives supported by the information technology application.

Preliminary observation:
At the user level, the data warehouse's front-end applications bring considerable improvement in diagnosing known issues, generating complete analyses and discovering unknown issues. This correlates with the fact that information and users' needs were previously assessed as sufficiently identified;
The generation of alternatives and the development of appropriate solutions are two areas for which the data warehouse's front-end applications are found not to bring improvement. This correlates with the fact that business requirements were previously assessed as incomplete.

### 6.9. Organizational Net Benefits Evaluation

### 6.9.1. Evaluation Questions

This part of the assessment addresses the question: What are the net benefits (positive impact) of the health data warehouse's front-end applications at the organizational level? After assessing the impact of the technology from an individual perspective, net benefits are evaluated at the organizational level. For the purpose of this demonstration, a single factor is used to address this question:
ONBE1. Contribution to Achieving the Organization's Goals and Mission: Has the capability of the organization to achieve its goals and mission been increased as a result of the use of the health data warehouse's front-end applications?

### 6.9.2. Metrics

The following metrics are used to collect measures to address the above question.
ONBE1.1. Increased ability to achieve the institution's goals and mission organization-wide
ONBE1.2. Increased ability to achieve the institution's goals and mission in financial and operational areas
ONBE1.3. Increased ability to achieve the institution's goals and mission in medical, clinical and nursing areas

### 6.9.3. Data Collection Methods

To collect measures on the above factor, a survey questionnaire is given to a statistically representative sample of users working in financial, medical, clinical and nursing areas in an upper-level management capacity. The questions use the same labelling as the metrics.

Using the scale where 1 indicates that you strongly disagree and 6 indicates
that you strongly agree, please rate the following statements:

| | Strongly | | Somewhat | Somewhat | | Strongly |
|---|---|---|---|---|---|---|
| | Disagree | Disagree | Disagree | Agree | Agree | Agree |
| ONBE1.1 The use of the data warehouse's front-end tools has | 1 | 2 | 3 | 4 | 5 | 6 |
| increased the ability to achieve the institution's goals and | | | | | | |
| mission organization-wide. | | | | | | |
| ONBE1.2. The use of the data warehouse's front-end tools | 1 | 2 | 3 | 4 | 5 | 6 |
| has increased the ability to achieve the institution's goals and | | | | | | |
| mission in financial and operational areas. | | | | | | |
| ONBE1.3 The use of the data warehouse's front-end tools has | 1 | 2 | 3 | 4 | 5 | 6, |
| increased the ability to achieve the institution's goals and | | | | | | |
| mission in medical, clinical and nursing areas. | | | | | | |

Additionally, interviews of or focus groups with the same staff members who took the survey can be conducted to give respondents the opportunity to expand on these statements.

### 6.9.4. Scoring

The following scores are attributed to the scale's items:
Strongly disagree: −5;
Disagree: −3;
Somewhat disagree: −1;
Somewhat agree: 1;
Agree: 3; and
Strongly agree: 5

Individual scores are assessed to identify patterns in responses and potential biases. The mean score of all items constitute the overall score. A positive score is interpreted as an increase in the organization's capability to achieve its goals and mission and a negative score as a lack of improvement in the organization's capability to achieve its goals and mission:
Scores of 4 to 5 indicate a considerable increase;
Scores of 2 to 3.99 indicate a moderate to significant increase;
Scores of 0.5 to 1.99 indicate a moderate increase;
Scores of −0.5 to 0.49 indicate a limited increase; and
Scores lower than −0.5 indicate a lack of improvement.

For the purpose of this demonstration, individual net benefits are said to be characterized by the following scores:

| | Strongly | | Somewhat | Somewhat | | Strongly | |
|---|---|---|---|---|---|---|---|
| | Disagree | Disagree | Disagree | Agree | Agree | Agree | Total Score |
| ONBE1.1 | 0 | 0 | 0 | 0 | 180/540 | 420/2,100 | 2,640:600 = 4.4 |
| ONE1.2 | 0 | 0 | 0 | 0 | 80/240 | 520/2,600 | 2,840:600 = 4.7 |
| ONE1.3 | 0 | 0 | 0 | 0 | 50/150 | 550/2,750 | 2,900:600 = 4.8 |
| Total | | | | | | | 4.6 |

With an overall score of 4.6, the data warehouse is found to considerably increase the achievement of the organization's goals and mission. Achievements are particularly important in medical and financial areas while being slightly less significant organization-wide.

### 6.9.5. Ranking

This demonstration involves a single factor for the assessment of organizational net benefits. However the chosen factor ranks first in this category and requires a score of 2 or above. Since the obtained score is 4.6, the ranking requirement is largely satisfied.

### 6.9.6. Additional Quantitative Data Analysis

The toolkit computes additional analyses for the organizational net benefits assessment. Instead of ratios, these additional analyses consist of correlations. The scores on the level of increase in the ability to achieve the organization's goals and mission are compared with the scores previously obtained on the organizational dimension, i.e. the areas targeted for process improvement and cost savings. These scores are also compared with the financial results generated by the initiatives supported by the information technology application

Preliminary Observation:

The data warehouse has a significant impact on how well the organization achieves its goals and mission. This correlates with the fact that process improvement and cost savings initiatives are well delineated across the organization and for each of the areas in which the achievements are obtained.

### 6.10. Outcome

Besides overall and individual scores, the outcome of the evaluation includes a set of recommendations for the objectives as defined in Section 4.1 and prioritizes those areas to be addressed in accordance with the scoring and ranking of the assessed factors. Moreover, the toolkit provides the means to monitor the results of the actions taken by the healthcare organization to address the recommendations.

### 6.10.1. Results

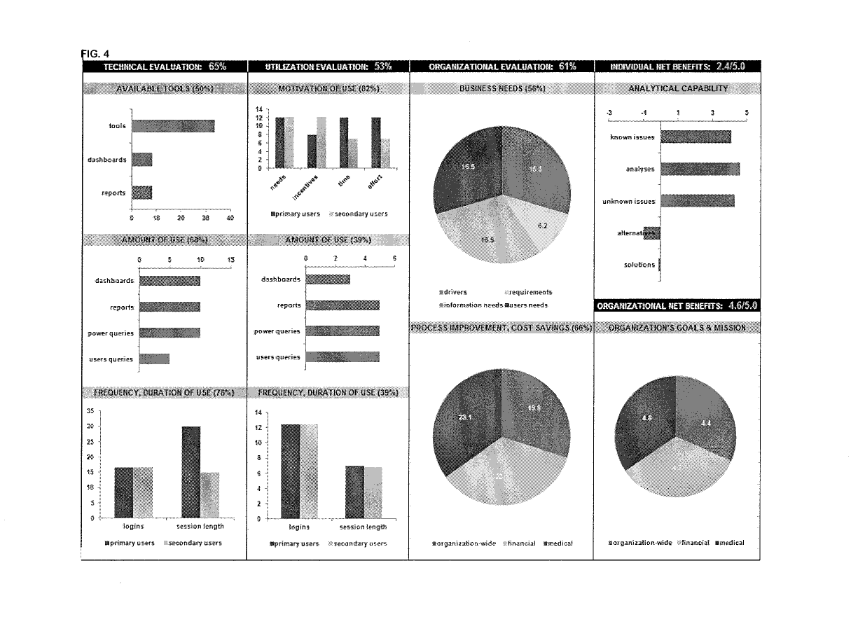

The toolkit presents the results of the evaluation in the form of a summary dashboard (see FIG. 4). This visual display of all individual scores provides at-a-glance views of the key trends, comparisons and exceptions which have been detailed in Sections 6.5 to 6.9.

The dashboard's columns vertically display the results of each of the evaluated components, including the total score of the component and the score of the individual factors assessed within this component.

The dashboard is also interpreted by following the horizontal flow of information from left to right. This enables the comparison across components of similar factors. The scenario constructed for this demonstration involves the comparison of the amount, frequency and duration of use across the technological and utilization dimensions. More importantly, the horizontal flow of information provides the explanatory value of the evaluation by showing how the results obtained on each component relate to the individual and organizational net benefits. In this demonstration, the low score on individual net benefits is linked to insufficient business requirements which did not accurately capture the specificities of the motivation for use. Similarly, a high score on organizational net benefits is directly linked to well-delineated opportunities for process improvement and cost savings at all levels of the organization.

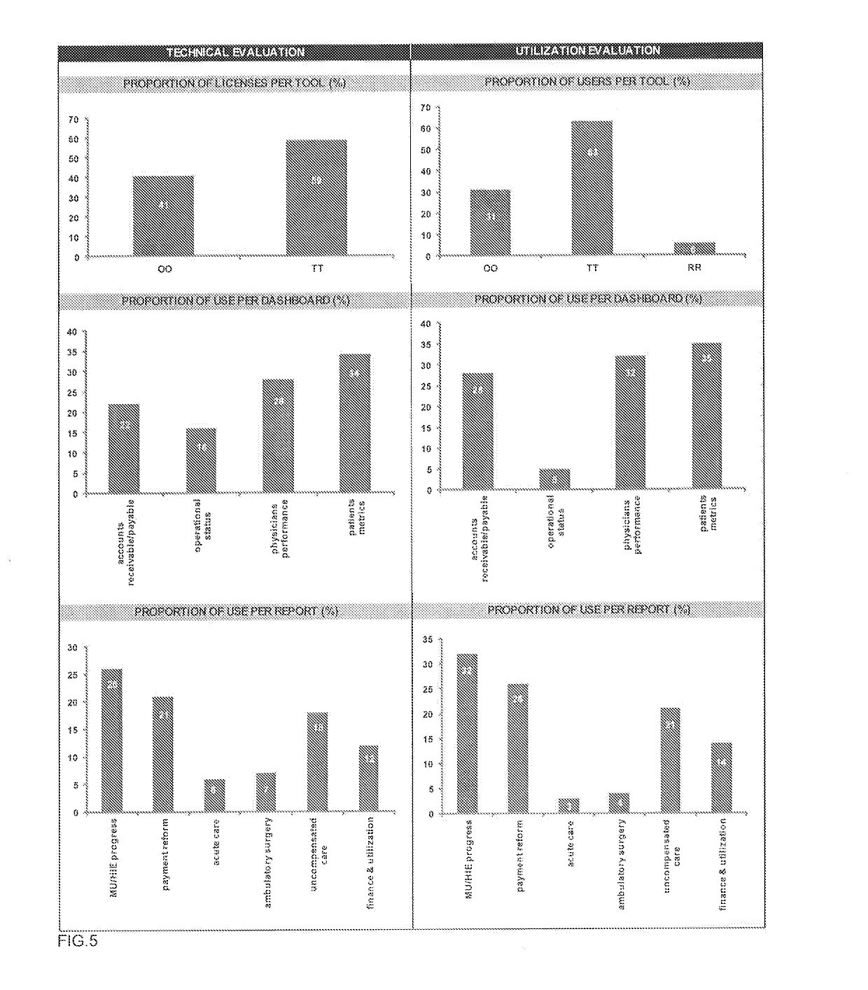

Based on the collected measures, when applicable, the toolkit processes a series of additional data analyses for each component. The results of these analyses are presented in a separate dashboard (see FIG. 5) that details the causes of the observed discrepancies. For the purpose of this demonstration, a more detailed analysis shows discrepancies between the number of front-end tools reported by the data warehousing staff and users. The analysis also indicates that one dashboard and two reports are underutilized.

### 6.10.2. Recommendations

In light of the above results, recommendations are made to enable the healthcare organization to take remedial actions to address the issues diagnosed over the course of the evaluation process.

In response to the issues identified in the context of the scenario constructed for the purpose of this demonstration, the following recommendations are made:

### Streamlining of Front-End Applications Portfolio

Multiple issues have been found with regard to the portfolio of front-end applications:
A statistical software was used by power users but not accounted for by the health data warehousing team;
There were fewer OO users than there were licenses registered for the software; and
There were more TT users than there were licenses registered for the software.

Application availability ranks highest in importance in the technological evaluation and should be remediated first. Failure to address these issues places the organization at risk of potential litigation with vendors due to unregistered licenses. Over- and under-utilization of licenses also represent a risk of sub-optimal return on investment.

### Business Needs Update

Even though higher than the minimum required, the score obtained on individual net benefits was low and included values in the negative range. The evaluation attributed the cause of these low scores to:
Incomplete business requirements; and
Only partial identification of business drivers.

Individual net benefits are a direct measure of the productivity that results from the use of the front-end applications. Issues impacting individual net benefits should be addressed immediately after those affecting the portfolio of applications. Updating the business requirements and business drivers are key to ensuring the prioritization and realization of technical and functional improvements. In this particular scenario, such improvements are critically needed to enable users to better generate alternatives and develop solutions. Such improvements would in turn strengthen the organization's capability to control its environment.

### Dashboards and Reports Streamlining

Multiple issues have also been found with regard to the output of the front-end tools:
Some dashboards and reports are considerably less used than others; and
Discrepancies in utilization were found between what was reported by users and what was reported by the health data warehousing team.

The amount of use ranks second in importance in both the technological and utilization evaluations and should be addressed last. The production of dashboards and reports for which there is little to no demand further diminishes return on investment. Addressing this issue would not only optimize resource utilization, it would also increase the capacity of the front-end tools.

### 6.10.3. Monitoring

The number and type of actions taken to implement the recommendations provided as a result of the evaluation are left to the discretion of the healthcare organization. However, the toolkit also monitors the implementation and results of such actions by replicating the initial data collection and focusing only on the concerned factors. This enables not only to follow up on the remedial actions but to assess whether these actions have produced their intended results. At this point, the evaluation toolkit requests a decision as to whether further evaluation is needed. If more is required, a new evaluation process must be started. Otherwise, the current assessment process ends and the evaluation is considered concluded.

### 6.11. Establishment of Standards and Benchmarking Data

As illustrated above, the toolkit enables the systematic collection of data and offers the means to develop dashboards and tracking mechanisms to establish baseline data at the organizational level. The metric data gathered for each individual organization is then compiled and aggregated by the toolkit to produce standards and benchmarking references at the sector or industry level. With regard to the example above, assessments produced for additional healthcare organizations on data warehousing would be aggregated to establish standards of use and performance from a technical, utilization and organizational standpoint across the healthcare sector.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

1-13. (canceled)

14. A computer implemented method of evaluating an information technology in a computer network having multiple applications and users, comprising:
programming a computer to create objective metric data of organizational dimension from surveys regarding business needs associated with each information technology application and the contributions each information technology application is intended to make toward advancing an organization's goals and mission, the resulting metric data comprising a minimum of:
a level of identification of business drivers for each information technology application;
a level of identification of areas targeted for process improvement by each information technology application; and
a level of identification of areas targeted for cost savings by each information technology application;
programming the computer to create objective metric data of utilization dimension from surveys regarding users' needs, their motivation for using each information technology application, the nature of their use of each information technology application, the resulting metric data comprising a minimum of:
an amount of use of each information technology application;
a frequency of use of each information technology application;
a duration of use of each information technology application;
a motivation of use of each information technology application; and
a nature of use of each information technology application;
programming the computer to create objective metric data of technical dimension as to actual use and performance of each information technology application by surveying usage of each information technology application by each of the multiple users, the resulting metric data comprising a minimum of:
a number of users;
an amount of use of each information technology application;
a frequency of use of each information technology application; and
a duration of use of each information technology application;
programming the computer to process the metric data of organizational dimension, the metric data of utilization dimension, and the metric data of technical dimension to determine the overall degree of utilization of each information technology application;
programming the computer to create objective metric data of individual net benefits to determine the positive impact of each information technology application on users' productivity, the resulting metric data comprising a minimum of:
a level of increase in analytical capability; and
programming the computer to create objective metric data of organizational net benefits to determine the positive impact of each information technology application on the organization as a whole, the resulting metric data comprising a minimum of:
a level of increase in the capability to achieve goals and mission.

15. The computer implemented method of claim 14, including programming the computer to create objective metric data of net benefits at a sector level to determine the positive impact of each information technology application on the industry to which users and their organization belong.

16. The computer implemented method of claim 15, including programming the computer to extract objective metric data on industry sector standards for the purpose of benchmarking whereby objective metric data of an organization under review is compared to objective metric data on industry sector standards.

17. The computer implemented method of claim 14, including programming the computer to group users based upon the nature of their duties.

18. The computer implemented method of claim 17, wherein the users are grouped into primary users and secondary users, primary users being users who have extensive knowledge of the advanced features of each information technology application and can access such application for the benefit of others, and secondary users being average users who only access each information technology application for themselves.

19. The computer implemented method of claim 17, wherein users are grouped into information technology staff, finance/operations staff, professional staff, and other stakeholders.

20. The computer implemented method of claim 19, including programming the computer to create metric data regarding number of queries run and number of reports produced compared to an analytical capability of each information technology application.

21. The computer implemented method of claim 14, including programming the computer to generate a score based upon predetermined criteria.

22. The computer implemented method of claim 21, wherein the computer generates a score for each individual metric of the metric data.

23. The computer implemented method of claim 22, wherein the computer is programmed to sum each score for each individual metric of the metric data to produce a global evaluation score.

24. The computer implemented method of claim 21, including establishing a plurality of assessment factors by clustering several metrics for each assessment factor, assigning relative importance to each of the metrics of the assessment factor through at least one of a ranking system or weighing system or both when computing the score to the assessment factor.

25. The computer implemented method of claim 24, wherein in computing the score the computer is programmed to rank in order of importance a hierarchy of dimensions, firstly the organizational dimension, secondly the utilization dimension and thirdly the technical dimension.

26. The computer implemented method of claim 25, wherein in computing the score the computer is programmed to rank in order of importance under each of the organizational dimension, the utilization dimension and the technical dimension, a hierarchy of components.

27. The computer implemented method of claim 26, wherein in computing the score the computer is programmed to rank in order of importance under each component of the hierarchy of components, a hierarchy of assessment factors.

28. The computer implemented method of claim 27, wherein in computing the score the computer is programmed to produce a number of pieces of metric data for each assessment factor of the hierarchy of factors.

29. The computer implemented method of claim 27, wherein in computing the score the computer is programmed to assign a relative weight to each piece of the number of pieces of metric data.

30. The computer implemented method of claim 21, including an exclusion mechanism wherein an immediate recommendation of remedial action is generated by the computer if a minimum score on a selected metric is not attained.

31. The computer implemented method of claim 21, including programming the computer to generate a dashboard of output scores.

32. The computer implemented method of claim 14, where an initial review becomes a baseline for further reviews of use and performance, and remedial efforts are taken to improve upon the baseline, programming the computer to create metric data on actual use and performance for a further time interval after the remedial action has been implemented to determine whether there has been an improvement in the baseline use and performance.
